(19) United States
(12) Patent Application Publication
(10) Pub. No.: US 2012/0311820 A1
(43) Pub. Date: Dec. 13, 2012

(54) Knob and process of manufacturing same

(76) Inventor: Po-Han Chang, Nantou (TW)

(21) Appl. No.: 13/157,300

(22) Filed: Jun. 9, 2011

(51) Int. Cl. E05B 1/00

(52) U.S. Cl. 16/110.1

(57) ABSTRACT

A knob and process of manufacturing same is provided. The knob includes a knob portion formed of plastic; and a shank portion comprising a first hollow cylindrical member including an annular flange extending outward at one end, and a second hollow cylindrical member including an annular flange extending outward at one end, the annular flange of the first hollow cylindrical member being disposed in alignment with the annular flange of the second hollow cylindrical member. The whole second hollow cylindrical member and a portion of the first hollow cylindrical member of the shank portion are within the knob portion. The plastic knob portion has increased traction.

### BACKGROUND OF THE INVENTION

1. Field of the Invention

The invention relates to knobs (e.g., door knobs and knobs on doors of a cabinet) and more particularly to a knob having a plastic knob portion with increased traction and process of manufacturing same.

2. Description of Related Art

Door handle (e.g., door knob) is used to open or close a door. Another type of door handle is door lever which has an advantage of tight grip by hand not required.

Conventional door knob made of metal (e.g., brass and copper) has a disadvantage of being low in traction. Hence, it is often that an individual may not get a better grip of knob when closing or opening a door.

Thus, the need for improvement still exists.

### SUMMARY OF THE INVENTION

It is therefore one object of the invention to provide a knob comprising a knob portion formed of plastic; and a shank portion comprising a first hollow cylindrical member including an annular flange extending outward at one end, and a second hollow cylindrical member including an annular flange extending outward at one end, the annular flange of the first hollow cylindrical member being disposed in alignment with the annular flange of the second hollow cylindrical member; wherein the whole second hollow cylindrical member and a portion of the first hollow cylindrical member of the shank portion are within the knob portion.

It is another object of the invention to provide a process of manufacturing a knob.

The above and other objects, features and advantages of the invention will become apparent from the following detailed description taken with the accompanying drawings.

### BRIEF DESCRIPTION OF THE DRAWINGS

FIG. 1 is a perspective view of two shaped parts of a shank portion to be secured in a process of manufacturing a knob according to the invention;

FIG. 2 is a perspective view of the parts of the shank portion being secured together;

FIG. 3 is a perspective view of an open mold showing three steps of positioning three shank portions in three cavities of the mold;

FIG. 4 is a perspective view of the mold showing a closed state after flowing molten plastic into the cavities, an open state after the plastic being hardened therein to form shaped knobs, and the shaped knobs being pivoted out of the cavities prior to removal;

FIG. 5 is a perspective view of the open mold of FIG. 4 showing the knobs having been removed out of the mold;

FIG. 6 is a sectional view of one of the knobs of FIG. 5 with the shank portion filled with hardened plastic;

FIG. 7 is a sectional view of another finished knob with the shank portion being hollow;

FIG. 8 is a sectional view taken along line 8-8 of FIG. 7;

FIG. 9 is a perspective view of the finished knob having a basketball shaped knob portion;

FIG. 10 is a perspective view of the knob of FIG. 9 being assembled with a escutcheon plate;

FIG. 11 is a perspective view of the knob of FIG. 10 mounted on a door;

FIG. 12 is a perspective view of a finished knob having a soccer ball shaped knob portion;

FIG. 13 is a perspective view of a finished knob having a baseball shaped knob portion;

FIG. 14 is a perspective view of a finished knob having a rugby ball shaped knob portion;

FIG. 15 is a perspective view of the knob of FIG. 14 assembled with a escutcheon plate;

FIG. 16 is a perspective view of a finished knob having a car wheel shaped knob portion; and

FIG. 17 is a perspective view of the knob of FIG. 16 assembled with a escutcheon plate.

### DETAILED DESCRIPTION OF THE INVENTION

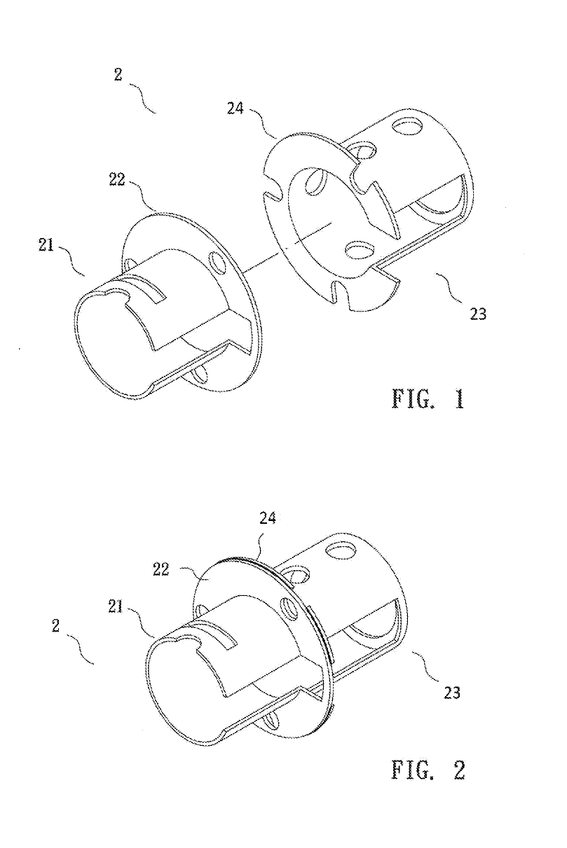

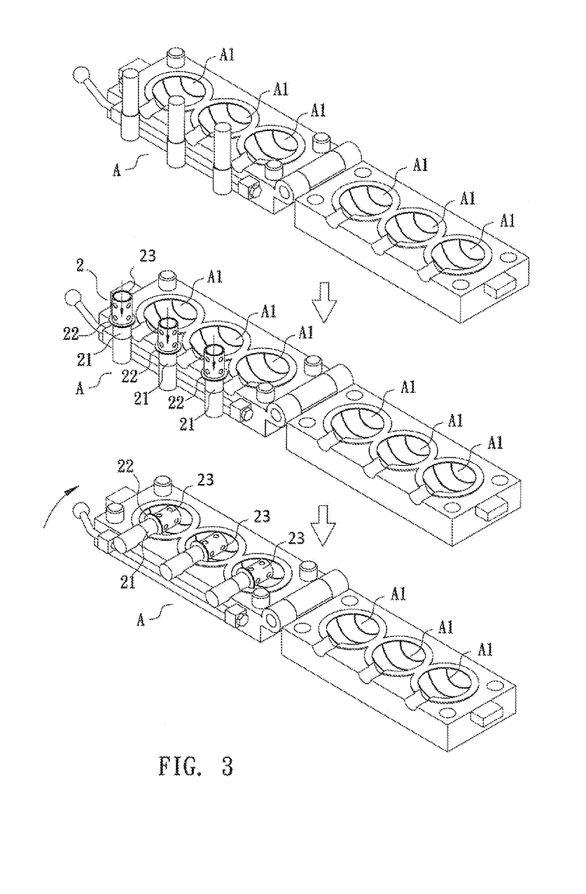

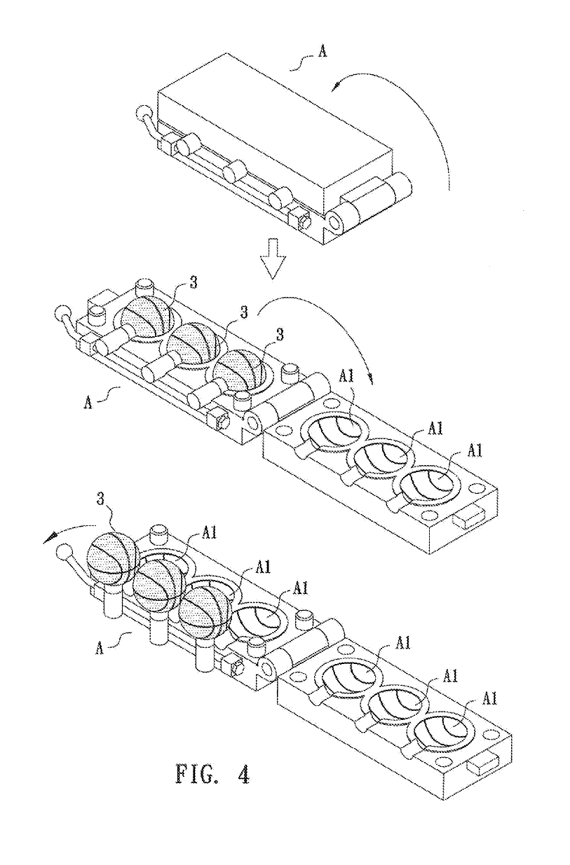

Referring to FIGS. 1 to 5, a process of manufacturing a knob in accordance with the invention is illustrated. Steps of the processes are detailed below.

A first hollow cylindrical member 21 comprises an annular flange 22 extending outward at one end. A second hollow cylindrical member 23 comprises an annular flange 24 extending outward at one end. The flanges 22, 24 are aligned and secured together by applying adhesive therebetween. As a result, a shank portion 2 is formed;

Each of a plurality of shank portions 2 is temporarily fastened on a post (not numbered) of a mold A. The shank portions 2 together are pivoted to rest upon cavities A1 of an ejector mold part of the mold A by pivoting a lever (not numbered). Next, an injection mold part of the mold A is pivoted onto the ejector mold part to close the mold A. Next, molten plastic is flowed into the cavities A1 as known in the art of injection molding. After cooling and opening the mold A, the hardened plastic is shaped around the whole second hollow cylindrical member 23 and a portion of the first hollow cylindrical member 21 of each shank portion 2 to form a knob portion 3. Next, turn the lever to pivot the finished knobs out of the cavities A1. Finally, remove the knobs.

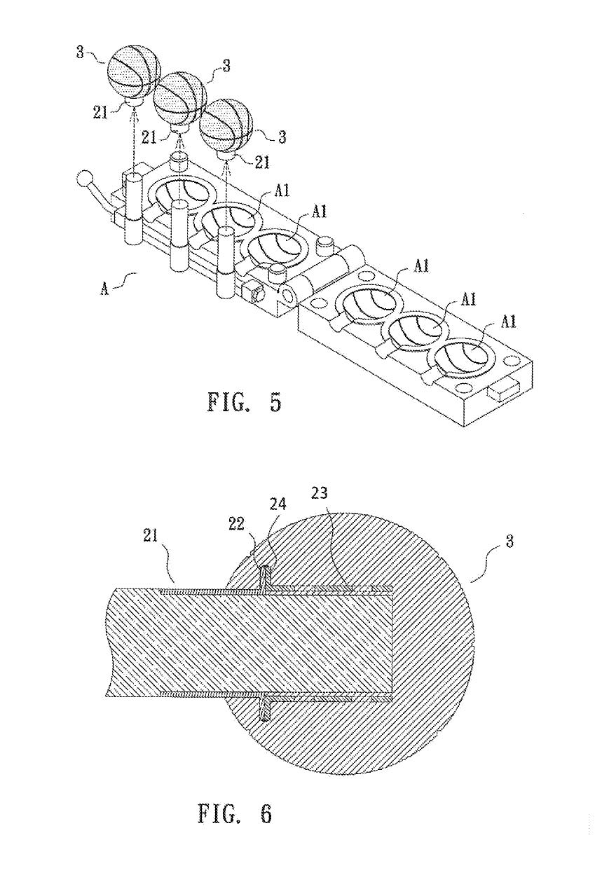

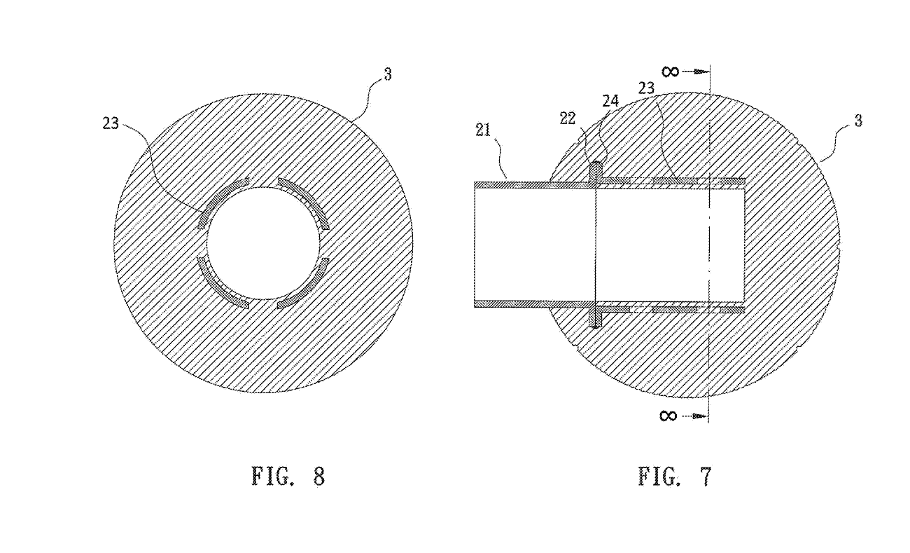

Referring to FIGS. 6 to 8, a knob of the invention can have either a solid shank portion (see FIG. 6) or a hollow shank portion (see FIGS. 7 and 8).

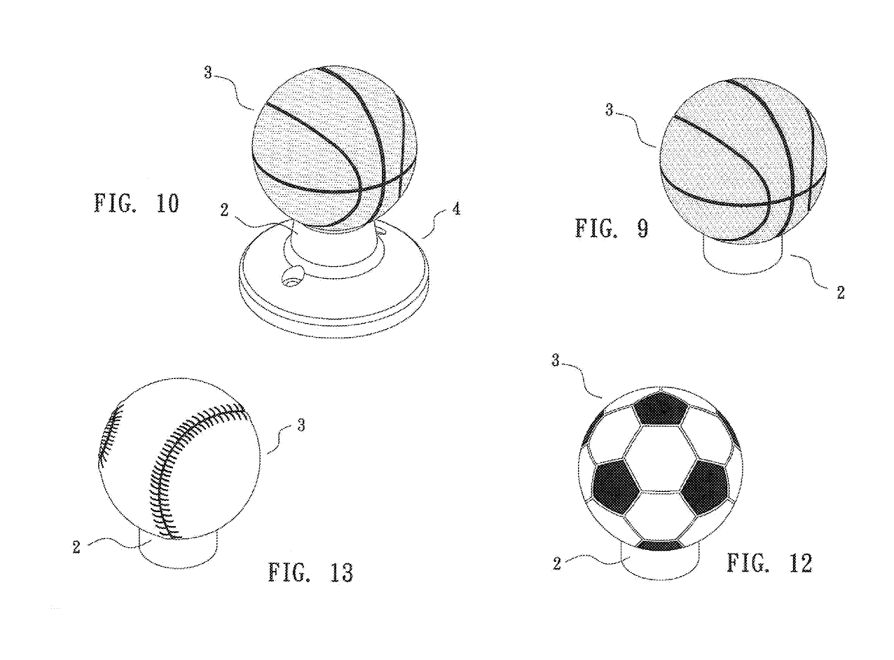

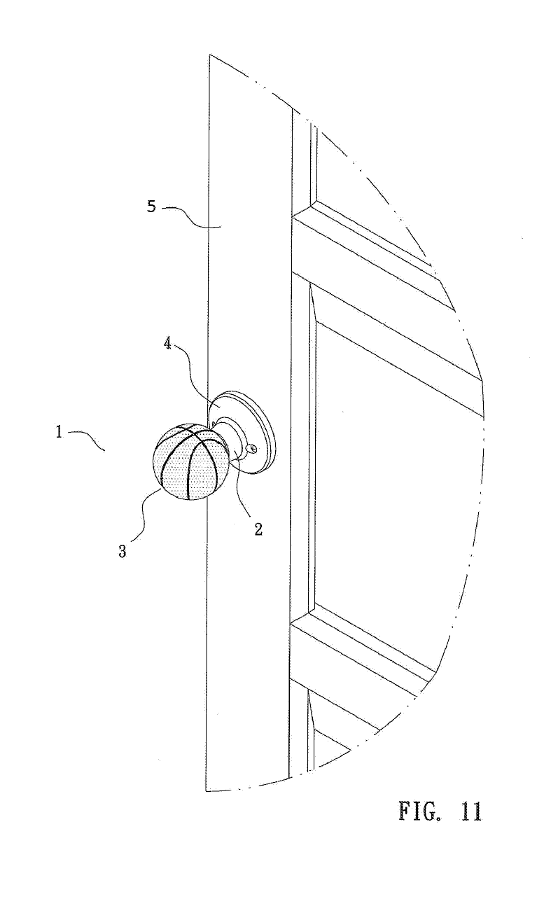

Referring to FIGS. 9 to 11, a knob 1 having a basketball shaped knob portion 3 and a cylindrical shank portion 2 of the invention is assembled with an escutcheon plate 4 prior to mounting on a door 5.

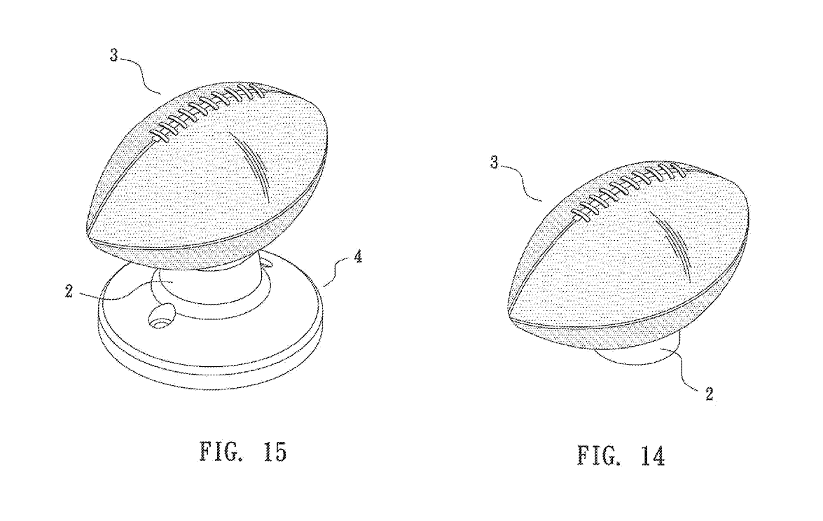

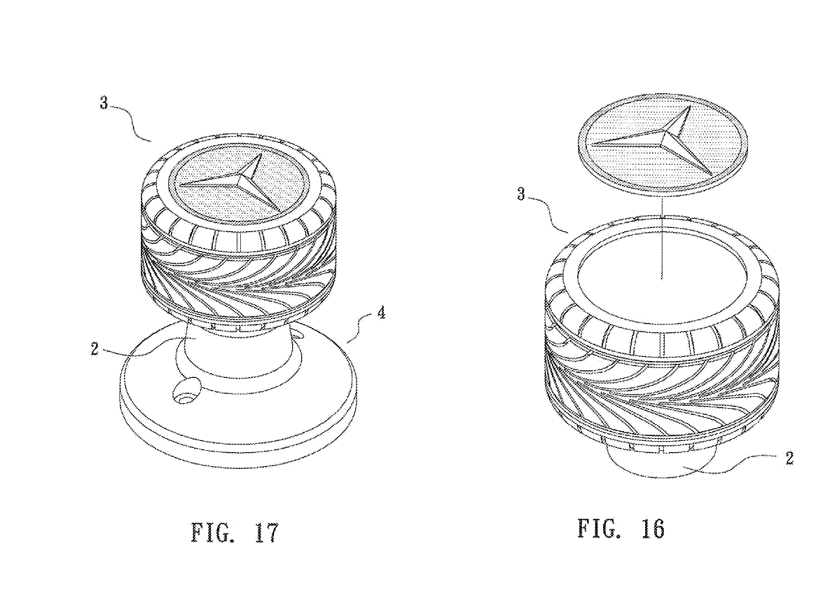

Referring to FIGS. 12 to 17, a knob portion 3 of a knob of the invention can be shaped as a soccer ball (see FIG. 12), a baseball (see FIG. 13), an oval rugby ball (see FIGS. 14 and 15), or a car wheel (see FIGS. 16 and 17).

It is envisaged that the plastic knob portion of a knob of the invention having a surface of high traction enables an individual to get a better grip thereon when opening or closing a door.

While the invention has been described in terms of preferred embodiments, those skilled in the art will recognize that the invention can be practiced with modifications within the spirit and scope of the appended claims.

What is claimed is:

1. A knob comprising:
a knob portion formed of plastic; and
a shank portion comprising a first hollow cylindrical member including an annular flange extending outward at one end, and a second hollow cylindrical member including an annular flange extending outward at one end, the annular flange of the first hollow cylindrical member being disposed in alignment with the annular flange of the second hollow cylindrical member;
wherein the whole second hollow cylindrical member and a portion of the first hollow cylindrical member of the shank portion are within the knob portion.
